(19) United States
(12) Patent Application Publication
(10) Pub. No.: US 2003/0044107 A1
(43) Pub. Date: Mar. 6, 2003

(54) Device and method of calibration for photonic switches

(76) Inventors: Samir Moustaffa Tamer, San Jose, CA (US); Robertus Petrus Van Kampen, Fremont, CA (US)

Correspondence Address: Pennie & Edmonds, LLP, 3300 Hillview Avenue, Palo Alto, CA, 94304, US

(21) Appl. No.: 09/944,352

(22) Filed: Aug. 30, 2001

(51) Int. Cl. G02B 6/35

(52) U.S. Cl. 385/18

(57) ABSTRACT

An optical calibration system calibrates an optical switch containing a mirror having one or more degrees of freedom, an input port receiving an optical signal from an optical signal source, and an output port. The calibration method includes identifying, within a sequence of coarse sweep positions, an initial position of the mirror that directs to the output port a reflected optical signal with at least a predetermined signal strength. A coarse step position of the mirror is then identified, within a sequence of coarse step positions separated by a coarse step size, whereby the reflected optical signal has a maximum signal strength. A fine step position of the mirror is then identified, within a sequence of fine step positions separated by a fine step size, whereby the reflected optical signal has a maximum signal strength. One or more calibration values associated with the identified fine step position are then stored.

### TECHNICAL FIELD

The invention relates generally to optical switches and micro-electromechanical systems (MEMS) or micro-optical-electromechanical systems (MOEMS). More particularly, the invention is directed to a device and method of calibrating an optical switch.

### BACKGROUND OF THE INVENTION

Fiber optics is the science or technology of light transmission through very fine, flexible glass or plastic fibers. These flexible fibers are typically bundled together into fiber optic cables, which are used in the telecommunications industry to transmit data. As the amount of data transmitted along separate fibers differ, it is desirable to dynamically allocate bandwidth over multiple fibers. This requires very quickly connecting and disconnecting optical signals between the fibers, where the connecting and disconnecting is known as switching. Furthermore, it is necessary to quickly switch signals between different customers, geographies, etc.

Historically, switching between different optical fibers was made using optical-electrical-optical (OEO) switches, which are network devices used to switch optical signals by converting an optical signal to an electrical signal, switching the electrical signal, and converting the switched electrical signal back into an optical signal. These OEO switches are network communication protocol dependent, consume more-power than all-optical switches, and have higher cross talk. Furthermore, OEO switches act as bottlenecks in a data stream of an optical network, since the electrical switching is slower than the optical data transmission rate. To address this, purely optical components such as optical cross-connects or optical switches are currently under development. These optical components switch high-speed optical signals and work entirely at the optical layer without having to convert to an electrical signal and back again.

A recent development for manufacturing these optical components utilizes micro-electromechanical systems (MEMS) technology. Micro-electromechanical systems combine electronics with micro scale mechanical devices, resulting in microscopic machinery, such as sensors, valves, gears, mirrors, and actuators embedded in semiconductor chips. The MEMS manufacturing process is similar to that used in the semiconductor industry, wherein silicon wafers are patterned via photolithography and etched in batch.

One class of MEMS optical devices use small, movable mirrors to redirect collimated light from an input fiber to an output fiber in an N×N matrix, where N input fibers can be arbitrarily linked to N output fibers. These type of MEMS optical devices are known as optical cross-connects or optical switches. A typical requirement of optical switches is that any input fiber is capable of being optically coupled to any output fiber. One common architecture that has emerged for optical switches based on movable MEMS mirrors is the so-called 2N type of MEMS optical switch.

FIG. 1A is a diagrammatic top view of a prior art 2N type optical switch module 100.

To route an optical signal 102 from an input port 104 to an output port 106, the optical signal 102 is reflected by two mirrors 108. Each mirror 108 is coupled to a multiple position movable mirror mount 109 to position the mirror. The mirrors 108 and mirror mounts 109 are disposed on an actuation plane or substrate 110 where each mirror 108 stands perpendicular to the substrate 110. The optical signal 102 travels through a plane that is parallel to the substrate 110.

FIG. 1B is a diagrammatic plan view of a mirror 108 coupled to a multiple position movable mirror mount 109 for use in the optical switch module 100 of FIG. 1A. When required to reflect an incoming beam of light, the mirror 108 and mirror mount 109 are rotated about an axis 120. For a 2N type optical switch, each mirror mount 109 must be able to rotate through numerous positions and must have at least one degree of freedom.

These multi-position mirror mounts 109 complicate the design, fabrication, and control of each mirror, thereby potentially making the 2N architecture more expensive per mirror than other optical switch architectures. The benefit of a 2N optical switch architecture, however, is that each additional input and output port set requires only two new mirrors and two mirror mounts, implying that the switching cost is linearly proportional to N. Therefore, for an N×N matrix of N input ports and N output ports, the 2N type optical switch architecture requires 2N mirrors and 2N mirror mounts.

In all optical switch architectures, efficient signal switching is essential in optical communications for directing an optical signal to an intended location. Optical switches may cause optical signal power loss due to misalignment of the optical signal from the optical input port to its intended optical output port. This increases the dependence on optical sources (e.g., optical amplifiers) that are used to compensate for these power losses by injecting optical power back into the optical system. The need for optical power sources increases the overall cost of the optical-system. In addition, since a typical optical switch has several optical input and output ports, efficient signal switching must be provided for any given input and output port combination.

In light of the above, a need exists for a simple and efficient calibration system for optical switches. The calibration system should be capable of providing fast and accurate optical alignment or coupling between one of several input ports to any one of several output ports of an optical switch. The calibration system should also be able to determine and store a set of calibration values for each input port to output port combination. The calibration values of a given input and output port combination may then be retrieved from a memory device and used to optically couple the given input port to the given output port.

### SUMMARY OF THE INVENTION

One aspect of the present invention is an optical calibration method for calibrating an optical switch containing a mirror configured to have one or more degrees of freedom, an input port receiving an optical signal from an optical signal source, and an output port. The calibration method includes positioning the mirror at a sequence of coarse sweep positions so as to identify an initial position of the mirror for which the mirror directs to the output port a reflected optical signal with at least a predetermined signal strength. The mirror is then positioned relative to the initial position, at a sequence of coarse step positions separated in accordance with a predefined coarse step size and identifying one of the coarse step positions for which the reflected optical signal has a maximum signal strength. The mirror is subsequently further positioned relative to the identified coarse step position, at a sequence of fine step positions separated in accordance with a predefined fine step size and identifying one of the fine step positions for which the reflected optical signal has a maximum signal strength. One or more calibration values associated with the identified fine step position are then stored in a memory device for later use.

Another aspect of the present invention is an optical calibration system that includes an optical switch having a mirror coupled to a mirror mount having at least one degree of freedom for positioning the mirror in response to a control signal, an input port configured for receiving an optical signal from an optical signal source, and an output port. An optical signal detector is optically coupled to the optical switch by the output port to receive the optical signal and to generate in response a feedback signal having an associated feedback signal strength. A controller, having a central processing unit and a memory device, is coupled to the optical signal detector to receive the feedback signal and is coupled to the mirror mount for sending the control signal to the mirror mount to position the mirror. The memory device stores instructions executable by the central processing unit, including instructions for operating the mirror mount to position the mirror to optically couple the input port to the output port. More particularly the instructions include coarse sweep instructions for positioning the mirror at an initial position to achieve a feedback signal with at least a predetermined feedback signal strength, coarse gradient search instructions, fine gradient search instructions and calibration storage instructions. The coarse gradient search instructions are for further positioning of the mirror, relative to the initial position, at a sequence of coarse step positions separated in accordance with a predefined coarse step size and identifying one of the coarse step positions for which the feedback signal has a maximum feedback signal strength. The fine gradient search instructions are for further positioning of the mirror, relative to the identified coarse step position, at a sequence of fine step positions separated in accordance with a predefined fine step size and identifying one of the fine step positions for which the feedback signal has a maximum feedback signal strength. The calibration storage instructions are for storing into a storage device calibration values associated with the identified fine step position.

### BRIEF DESCRIPTION OF THE DRAWINGS

For a better understanding of the nature and objects of the invention, reference should be made to the following detailed description, taken in conjunction with the accompanying drawings, in which:

FIG. 1A is a diagrammatic plan view of a 2N type optical switch module;

FIG. 1B is a diagrammatic plan view of a mirror coupled with a multiple position movable mirror mount for use in the optical switch module 100 of FIG. 1A;

FIG. 2A is a diagrammatic representation of an optical calibration system for a 2N optical switch module;

FIG. 2B is a diagrammatic representation of an optical calibration system for a 2N optical switch module with an alternative mirror configuration;

FIG. 3 is diagrammatic representation of a controller used in the optical calibration systems of FIGS. 2A and 2B;

FIG. 4 is a flow chart of the overall calibration process for determining and storing the calibration values of an optical switch;

FIG. 5 is a flow chart of a coarse sweep procedure used in the calibration process;

FIG. 6 is a flow chart of a coarse gradient search procedure used in the calibration process; and

FIG. 7 is a flow chart of a fine gradient search procedure used in the calibration process.

Like reference numerals refer to corresponding parts throughout the several views of the drawings.

### DETAILED DESCRIPTION OF THE PREFERRED EMBODIMENTS

To address the aforementioned needs, an optical calibration system has been developed. The optical calibration system of the present invention determines calibration values for accurately coupling each input port te each of several output ports of an optical switch. The calibration values are stored for later use. Typically, the calibration values of the optical switches are determined and stored in a factory setting. Afterwards, the optical switches may be used in a field setting where the calibration values are recalled to optically couple various input and output port combinations.

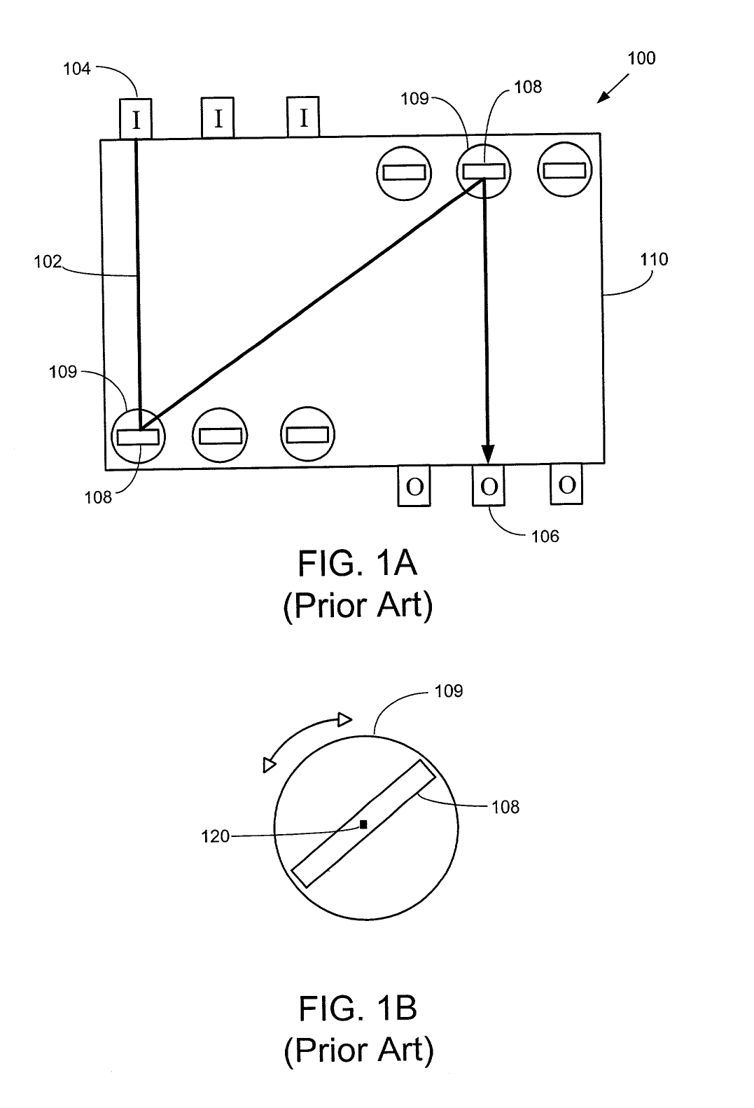

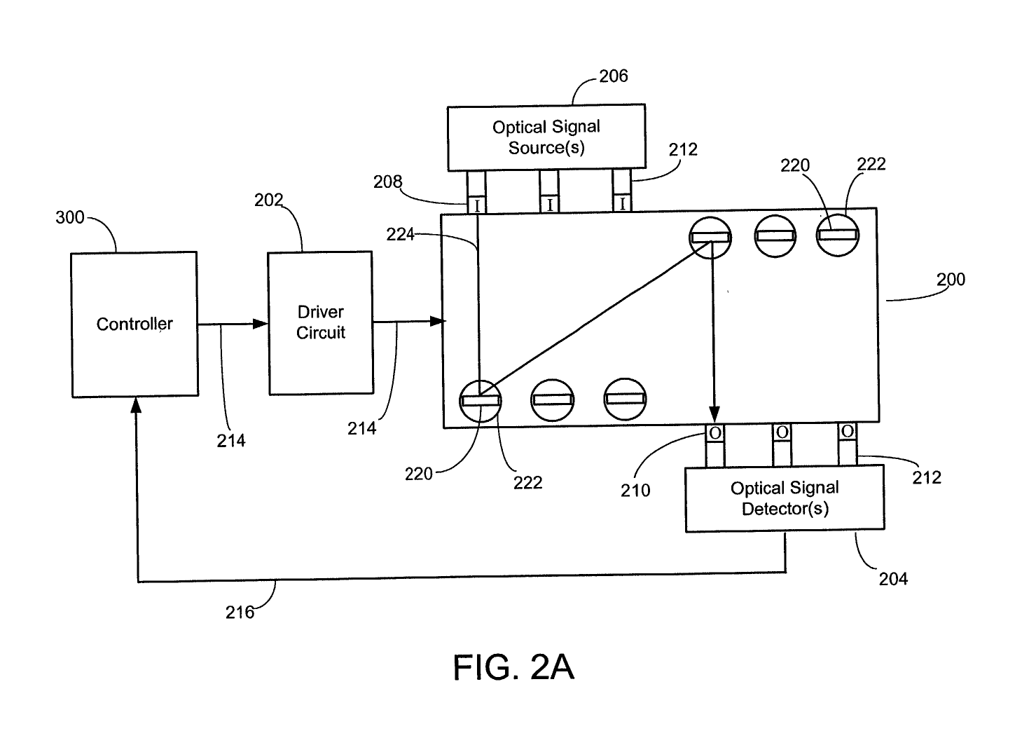

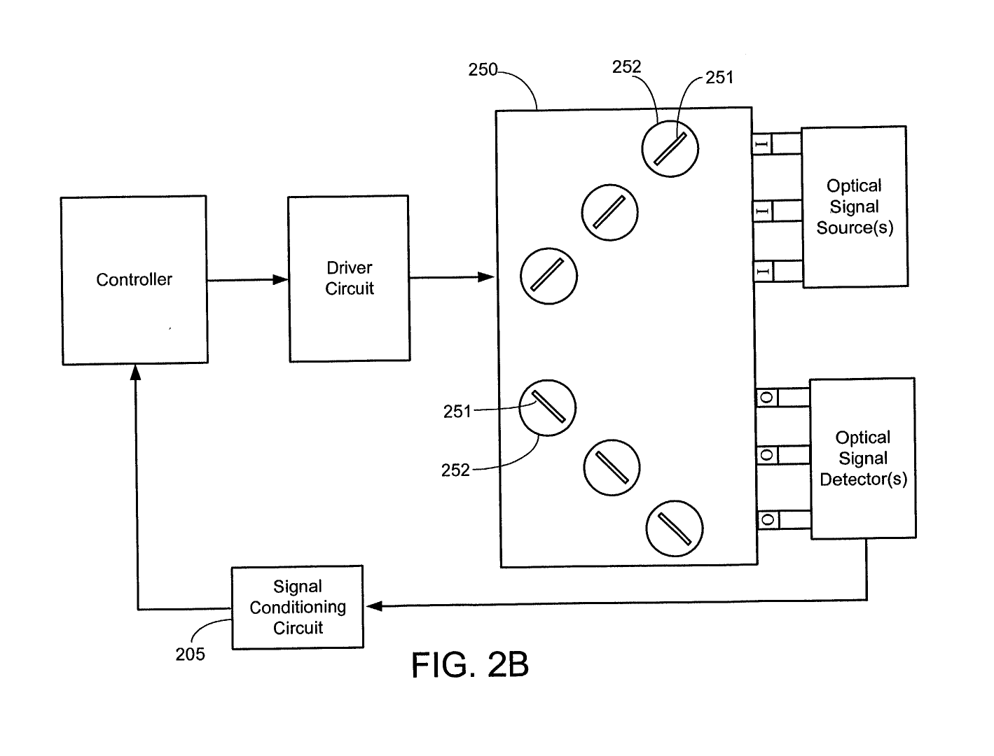

To determine the calibration values of an optical switch, the optical switch is connected to a dedicated optical calibration system as shown in FIG. 2A. The optical calibration system shown in FIG. 2A is designed to calibrate a 2N type optical switch module, such as the optical switch module 100 of FIG. 1A. The optical calibration system of FIG. 2A, however, is shown only as an exemplary model. The optical calibration system of the present invention can also be designed for different optical switch architectures and mirror configurations without departing from the invention. For example, FIG. 2B shows an optical calibration system designed for a 2N type optical switch module with an alternative mirror configuration. The optical switch that is to be calibrated is preferably a micromachined optical switch fabricated using MEMS technology.

### Optical Calibration System

Referring back to FIG. 2A, the optical calibration system of the present invention preferably includes a controller 300, a driver circuit 202, one or more optical signal detectors 204, and one or more optical signal sources 206. The optical calibration system is designed to calibrate an optical switch module 200.

Each optical signal source 206 is optically coupled to an input port 208 of the optical switch 200, preferably by an optical fiber 212. Each optical signal detector 204 is optically coupled to an output port 210 of the optical switch 200, also preferably by an optical fiber 212.

The optical signal source 206 sends an optical signal 224 through an optical fiber 212 and an input port 208. The optical signal 224 is reflected by mirrors 220 mounted on mirror mounts 222 inside the optical switch 200. For a 2N type optical switch, such as optical switch 200, the optical signal 224 is reflected by two moveable mirrors 220. The optical signal 224 is then received by an optical signal detector 204 through an output port 210 and an optical fiber 212.

The optical signal detectors 204 are coupled to the controller 300 by a feedback line. In response to receiving the optical signal 224, an optical signal detector 204 sends a feedback signal 216 to the controller 300 through the feedback line.

The controller 300 is coupled to the driver circuit 202 by one or more control lines carrying one or more control signals 214. In response to receiving the feedback signal 216, controller 300 sends a control signal 214 to the driver circuit 202 through a control line.

The driver circuit 202 is coupled to each mirror mount 222 contained in the optical switch 200 by one or more control lines. The driver circuit 202 passes on the control signals 214 received from the controller 300 to the mirror mounts 222 through the one or more control lines.

In a preferred embodiment, the optical switch 200, controller 300, and the driver circuit 202 are contained in the same housing. Therefore, when used in the field, various input and output port combinations of the optical switch 200 can be optically coupled without reliance on an external controller or driver circuit. Alternatively, the controller 300 and the driver circuit 202 are contained in a housing external to a housing containing the optical switch 200.

### Optical Switch

The optical switch 200 is a 2N type module that includes a plurality of mirrors 220, each mirror 220 being coupled to a multiple position movable mirror mount 222. For positioning a mirror 220, a mirror mount 222 has one or more degrees of freedom and can tilt or rotate about one or more orthogonal axes. Preferably, the 2N type optical switch 200 uses mirror mounts 222 with one degree of freedom. In an alternate embodiment, the 2N type optical switch 200, may contain mirror mounts with two degrees of freedom: a first rotational degree of freedom for rotating the mirror about a primary axis, for optically connecting different input/output port pairs, and a second degree of freedom for adjusting the vertical tilt of the mirror so as to vertically adjust where the reflected beam hits a target location, such as an output port or another mirror. The range of mirror movement associated with the second degree of freedom may be much smaller than the range of movement associated with the first degree of freedom.

Each mirror mount 222 is coupled to the driver circuit by a control line carrying a control signal 214 that is used to operate the mirror mount 222. Preferably, the mirror mount 222 is comprised of an electrostatic comb-drive actuator that receives a drive voltage via the control signal 214. The amount of drive voltage supplied by the control signal 214 determines a corresponding amount of tilt or rotation in the mirror mount 222. As used herein, a calibration value for a particular mirror 220 refers to the calibration voltage or the amount of drive voltage used in positioning the mirror 220 to optically couple a given input and output port combination. Applying the calibration value or the calibration voltage to a mirror mount 222 coupled to the mirror 220 results in a corresponding mirror position that optically couples a given input port to a given output port.

Alternatively, the mirror mount 222 may be an actuator that adjusts the position of the mirror 220 by receiving a driving source (such as a voltage, current, magnetic field, or temperature). Such an actuator may include, for example, an electrostatic comb-driver, an electrostatic actuator, a magnetostatic actuator, a piezoelectric actuator, and a thermal bimorph.

A more detailed explanation of such actuators may be found in either: U.S. Pat. No. 5,025,346, “LATERALLY DRIVEN RESONANT MICROSTRUCTURES”; Judy, J. W., Muller, R. S., Zappe, Magnetic microactuation of polysilicon flexure structures, H. H, Journal of Microelectromechanical Systems, Volume: 4 Issue: Dec. 4, 1995 Page(s): 162-169; Lin, L. Y., Lee, S. S., Pister, K. S. J., Wu, Micro-machined three-dimensional micro-optics for integrated free-space optical system, M. C. IEEE Photonics Technology Letters, Volume: 6 Issue: Dec. 12, 1994 Page(s): 1445-1447; Ataka, M.; Omodaka, A.; Takeshima, N.; Fujita, H, Fabrication and operation of polyimide bimorph actuators for a ciliary motion system, Journal of Microelectromechanical Systems, Volume: 2 Issue: Dec. 4, 1993. P 146-150; or M. Hoffmann, P. Kopka, E. Voges, Bistable micromechanical fiber-optic switches on silicon with thermal actuators, Sensors and Actuators, Volume 78, 1999. Pages 28-35, all of which are incorporated herein by reference.

A mirror 220 used in the optical switch 200 may be any suitable reflective device, such as a plane mirror or a curved mirror. The reflective device can be rigid or flexible and can range in size from 10 micrometers to several millimeters. The shape of the reflective device may be square, rectangular, circular, oval, or any other shape consistent with effectively reflecting an optical beam to a target location.

The optical switch 200 also includes one or more distinct optical input ports 208 and one or more distinct optical output ports 210. To transmit the optical signal 224 from an input port 208 to an output port 210 in an efficient manner, the optical signal 224 must hit the center of the intended output port 210 in a line parallel with the intended output port 210. Otherwise, there will be a large amount of signal intensity loss of the optical signal 224 at the intended output port 210.

### Optical Calibration System Devices

Each of the optical signal sources 206 is preferably a laser diode. Many different types of laser diodes with different wavelengths are used for different communication systems. For the optical calibration system of the present invention, the optical signal source 206 preferably emits a steady optical signal of at a predefined wavelength. An optical signal source 206 may be provided for each input port 208. However, a single optical signal source 206 may be used by sequentially optically coupling the optical signal source 206 to each input port 208 and then calibrating the mirrors used to couple that input port to the various output ports of the switch.

Each of the optical signal detectors 204 may be a photodiode, or any other suitable type of light sensor or meter. Upon receiving an optical signal 224, the optical signal detector 204 sends a feedback signal 216 through a feedback line to the controller 300.

The feedback signal 216 has an associated feedback signal strength Pₒᵤₜ corresponding to the signal strength or intensity of the reflected optical signal 224 received at the optical signal detector 204. A relatively high feedback signal strength Pₒᵤₜ indicates an efficient optical coupling between the input port 208 and the output port 210. Preferably, an optical signal detector 204 is provided for each output port 210. However, a single optical signal detector 204 may be used by optically coupling the optical signal detector 204 to any output port 210 for which one or more mirrors are currently being calibrated.

The controller 300 receives a feedback signal 216 from the optical signal detector 204 and processes the feedback signal 216. Based on the results of the feedback signal processing, the controller 300 sends a drive voltage contained in a control signal 214 to the driver circuit 202. The value of the drive voltage is based on the feedback signal strength Pₒᵤₜ associated with the prior received feedback signal 216. The drive voltage is adjusted by the controller 300 to produce a stronger feedback signal strength Pₒᵤₜ.

The controller 300 is coupled to the driver circuit 202 by one or more control lines carrying one or more control signals 214. The driver circuit 202 is coupled to each mirror mount 222 of the optical switch 200 by a control line 214. The driver circuit 202 passes on the control signals 214 received from controller 300 to the intended mirror mounts 222. The driver circuit 202 preferably includes a digital-to-analog converter to convert a digital control signal sent by the controller 300 to an analog control signal to send to the mirror mounts 222. Alternatively, the digital-to-analog converter may be housed within the controller 300 itself. Preferably, the driver circuit 202 also includes a voltage source operated by the controller 300 to power the mirror mounts 222.

As stated above, FIG. 2B shows an optical calibration system designed for a 2N type optical switch module 250 with an alternative mirror configuration. As shown in FIG. 2B, the alternative mirror configuration places mirrors 251 and mirror mounts 252 in a different pattern than shown in FIG. 2A. The optical calibration system designed for the optical switch module 250 containing the alternative mirror configuration, however, includes the same components and operates in the same manner as the optical calibration system designed for the optical switch module 200 of FIG. 2A.

### Controller

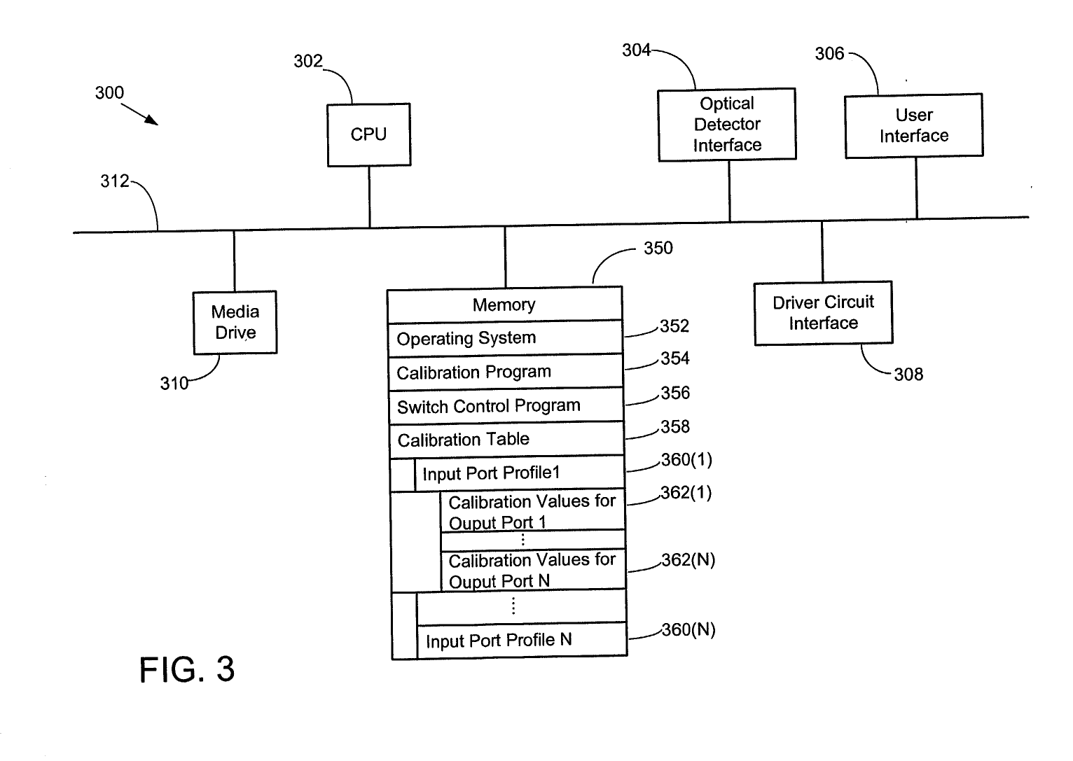

As shown in FIG. 3, the controller 300 includes a user interface 306, a driver circuit interface 308, an optical detector interface 304, central processor unit (CPU) 302, a memory device 350, and a media drive 310, all of which are interconnected by one or more internal communication busses 312.

The CPU is used to process instructions contained in the memory device 350, process 10 the feedback signal (216 of FIG. 2A) received from the optical signal detector (204 of FIG. 2A), and to determine the control signals (214 of FIG. 2A) to be sent to the driver circuit (202 of FIG. 2A). The driver circuit interface 308 receives the control signals determined by the CPU 302 and sends the control signals to the driver circuit (202 of FIG. 2A). The driver circuit interface 308 may include a digital-to-analog converter to convert a digital control signal received from the CPU 302 to an analog control signal to send to the driver circuit (202 of FIG. 2A). Alternatively, the digital-to-analog converter may be housed within the driver circuit (202 of FIG. 2A) itself.

The optical detector interface 304 is used to receive the feedback signal (216 of FIG. 2A) from the optical signal detector (204 of FIG. 2A) and to send the feedback signal to the CPU 302 for processing. The optical detector interface 304 may include a signal conditioning circuit such as a logarithmic amplifier (to amplify or strengthen the feedback signal) or noise-reducing filter (to remove high frequency noise). The optical detector interface 304 may further include an analog-to-digital converter to convert an analog feedback signal received from the optical signal detector (204 of FIG. 2A) to a digital feedback signal to send to the CPU 302. Alternatively, as shown in FIG. 2B, a signal conditioning circuit 205 may be coupled between the optical signal detector 204 and the controller 300.

The user interface 306 manages the input/output transactions between the controller 300 and a user operating the controller 300.

The memory device 350 contains instructions executable by the CPU 302. The memory device 350 may include an operating system 352 (such as CMX-RTX™, DSP/BIOS™, PharaOS™, DOS, UNIX™, Windows™, Linux™m, OS/2™, AS/400™, PalmOS™, AIX™, NEXTSTEP™, OS/390™, OS/9™, OS/90000™, VMS™, CP/M™, Solaris™, or MacOS™), that includes instructions for communicating, processing data, accessing data, storing data, searching data, etc. The memory device 350 may also include a calibration program 354 and a switch control program 356. The calibration program 354 is used to determine and store the calibration values for an optical switch (200 of FIG. 2A). The switch control program 356 is used to test the calibration values determined by the calibration program 354.

Preferably, the memory device 350 further includes a calibration table 358 containing an input port profile 360(1) to 360(N) for each input port 208 (FIG. 2A) of the optical switch 200 (FIG. 2A) being calibrated. Each input port profile 360(1) to 360(N) preferably contains an output port data field 362(1) to 362(N) for each output port 210 (FIG. 2A) of the optical switch being calibrated. Each output port data field 362(1) to 362(N) stores the calibration values for the output port associated with the output port data field 362(1) to 362(N) and the input port associated with the input port profile 360(1) to 360(N) in which the output port data field 362(1) to 362(N) is contained. For a 2N type optical switch, such as optical switch 200 shown in FIG. 2A, two calibration values are stored for each output port (210 of FIG. 2A), one calibration value being stored for each of mirror (220 of FIG. 2A) used to reflect the optical signal (224 of FIG. 2A). The calibration values are preferably stored as digital calibration values in the output port data fields 362(1) to 362(N).

The media drive 310 is used to write data, such as the calibration values for an optical switch, to a storage device. The storage device used to store data, for example, may be a hard disk, a floppy disk, a compact disk (CD), an electrically erasable programmable read only memory (EEPROM), or a flash memory. Preferably, the storage device is internal to the controller 300. In an alternative embodiment, the storage device may be external to the controller 300 and the data stored therein may be uploaded to the controller 300. In a further embodiment, the storage device is internal to the optical switch (200 of FIG. 2A).

### Overall Calibration Process

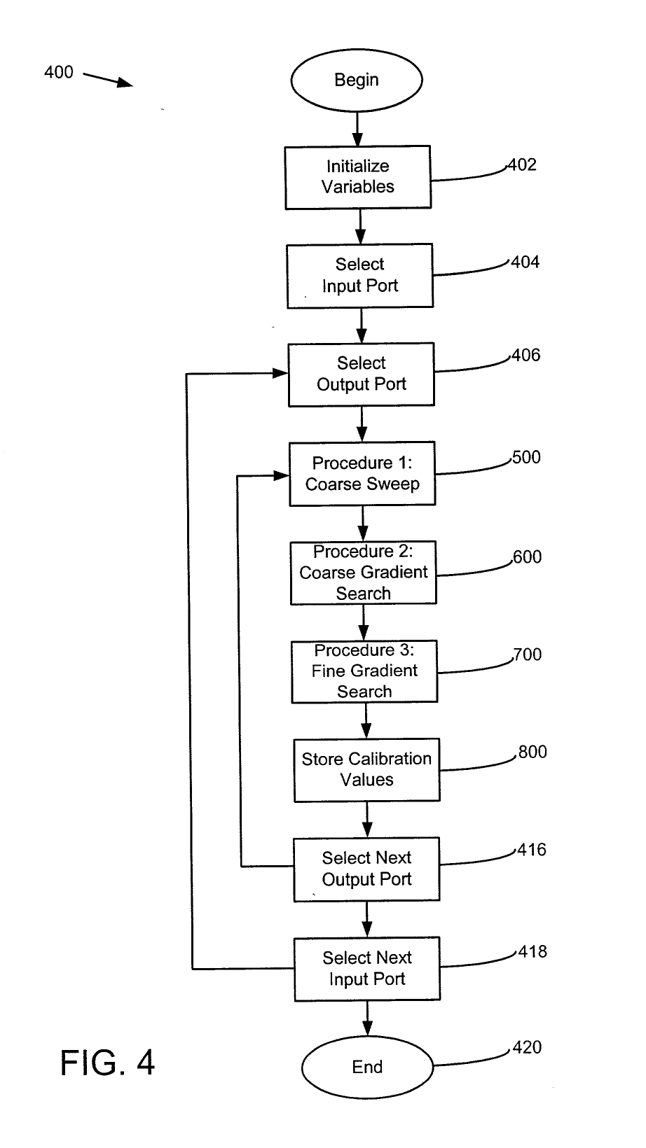

FIG. 4 is a flow chart of the overall calibration process 400 for determining and storing the calibration values of an optical switch 200 (FIG. 2A).

Referring to FIGS. 2A, 3 and 4, the calibration process 400 operates the mirror mounts 222 of an optical switch 200 to position the mirrors 220 to optically couple an input port 208 to each of the plurality of output ports 210. The resulting positions of the mirrors 220 have associated calibration values that are preferably stored in the memory device 350.

When used to calibrate 2N type optical switches (200 of FIG. 2A and 250 of FIG. 2B), the calibration process 400 calibrates the positions of a first and second mirror in the optical signal path. When the calibration process 400 is used to calibrate an optical switch containing a mirror mount with two degrees of freedom, the first degree of freedom is calibrated in the same manner as the first mirror and the second degree of freedom is calibrated in the same manner as the second mirror. For clarity, however, the procedures of the calibration process 400 will be described only in relation to a first and second mirror in the optical signal path.

An embodiment of the calibration process 400 is stored in the memory device 350 (FIG. 3) of the controller (300 of FIG. 2A) as the calibration program (354 of FIG. 3). The calibration program (354 of FIG. 3) includes instructions, executable by the CPU (302 of FIG. 3), that perform the procedures described below.

The calibration process 400 begins at 402 when the CPU (302 of FIG. 3) initializes certain system variables. The values for the initialized system variables may be read, for example, from a data file contained on a floppy disk or other non-volatile memory medium, or they may be incorporated into the calibration program itself or in a set of configuration files stored in memory 350 (FIG. 3). These system variables may include, for example, a predefined feedback signal strength P_{trig} used in a coarse sweep procedure and a predefined minimum feedback signal strength Pₘᵢₙ used in the switch control program (356 of FIG. 3).

These system variables may also include predefined step sizes such as a sweep step size for a coarse sweep, a coarse step size for a coarse gradient search, and a fine step size for a fine gradient search. As used herein, a predefined step size defines the amount of adjustment made to a drive voltage applied to a mirror mount 222 (FIG. 2A) in a single increment and the corresponding adjustment made to the position of a mirror 220 (FIG. 2A) by the single increment. A predefined step size may also be different for each mirror. For example, a predefined coarse step size for a first mirror may be larger than a predefined coarse step size for a second mirror. In addition, to speed the calibration process 400, the sweep step size used in the coarse sweep procedure and the coarse step size used in the coarse gradient search procedure may be increased.

Preferably, the initialized system variables also include for each mirror 220 (FIG. 2A) in the optical switch 200 (FIG. 2A), a range of drive voltages for each input and output port combination requiring use of the mirror for optical coupling. A range of drive voltages includes a minimum and maximum drive voltage (Vₘᵢₙ and Vₘₐₓ) predicted to contain the drive voltage needed to-optically couple a given input and output port combination. The predicted range of drive voltages may be based upon, for example, past experience and nominal system geometry.

At 404, an input port is selected from the plurality of input ports 208 (FIG. 2A) for calibration. At 406, an output port is selected from the plurality of output ports 210 (FIG. 2A) to be optically coupled to the input port selected at 404.

At 500, a coarse sweep procedure is executed for initially positioning a first and selected output port. The first and second mirrors are adjusted using a predefined sweep step size so as to achieve a feedback signal (216 of FIG. 2A) with at least a predetermined feedback signal strength P_{trig}. By achieving a feedback signal (216 of FIG. 2A) with at least a predetermined feedback signal strength P_{trig}, it is ensured that noise in the optical calibration system does not cause the coarse sweep procedure to be terminated prematurely.

At 600, a coarse gradient search procedure is executed for further positioning the first and second mirror 220 (FIG. 2A) relative to the initial positioning of the first and second mirrors determined in the coarse sweep procedure at 500. The first and second mirrors are positioned using a predefined coarse step size so as to achieve a feedback signal (216 of FIG. 2A) with a maximum feedback signal strength P_{cmax} given the coarse step size. The maximum feedback signal strength P_{cmax} should be greater than the predetermined feedback signal strength P_{trig} used in the coarse sweep procedure 500.

At 700, a fine gradient search procedure is executed for yet further positioning the first and second mirror relative to the positioning of the first and second mirrors determined by the coarse gradient search procedure at 600. The first and second mirrors are positioned using a predefined fine step size so as to achieve a feedback signal (216 of FIG. 2A) with a maximum feedback signal strength P_{fmax} given the fine step size. The maximum feedback signal strength P_{fmax} should be greater than the maximum feedback signal strength P_{cmax} determined in the coarse gradient search procedure 600.

At 800, distinct calibration values or drive voltages associated with the first and second mirror positions determined by the fine gradient search procedure at 700 are stored in a storage device. Preferably, the distinct calibration values are stored in the memory device 350 (FIG. 3) contained in the controller 300 (FIG. 2A). Specifically, the calibration values are stored in the input port profile (360(1) to 360(N) of FIG. 3) associated with the selected input port being calibrated, the input port profile being located in the calibration table 358 (FIG. 3) of the memory device 350 (FIG. 3). Within the input port profile (360(1) to 360(N) of FIG. 3), the calibration values are stored in the output port data field (362(1) to 362(N) of FIG. 3) associated with the selected output port being calibrated. For a 2N type optical switch (200 of FIG. 2A), two calibration values are stored for each input and output port combination, one calibration value being stored for each of the first and second mirrors (220 of FIG. 2A) used to reflect the optical signal (224 of FIG. 2A).

At 416, the next output port is selected for calibration. The calibration process steps 500 to 800 are then repeated for each output port 210 (FIG. 2A) in the optical switch 200 (FIG. 2A). After calibration values are determined and stored for each output port 210 (FIG. 2A), the next input port 208 (FIG. 2A) is selected at 418. The calibration process steps 500 to 800 and step 416 are then repeated for each input port 208 (FIG. 2A) in the optical switch 200 (FIG. 2A). After calibration values are determined and stored for each input port 208 (FIG. 2A), the calibration process 400 ends at 420.

The calibration process 400 determines and stores calibration values for all input and output port combinations of an optical switch (200 of FIG. 2A). The calibration values may then be later tested by a switch control program (356 of FIG. 3) that contains instructions executable by the CPU (302 of FIG. 3) of the controller (300 of FIG. 2A). Using the stored calibration values, the switch control program (356 of FIG. 3) operates the optical switch 200 (FIG. 2A) to test each input and output port combination. The switch control program 356 (FIG. 3) determines if a feedback signal strength Pₒᵤₜ produced by an input and output port combination exceeds a predefined minimum feedback signal strength Pₘᵢₙ required for an optical coupling. If an input and output port combination does not produce at least the predefined minimum feedback signal strength Pₘᵢₙ, the switch control program 356 (FIG. 3) may tag the input and output port combination for recalibration using the calibration process 400.

### Coarse Sweep Procedure

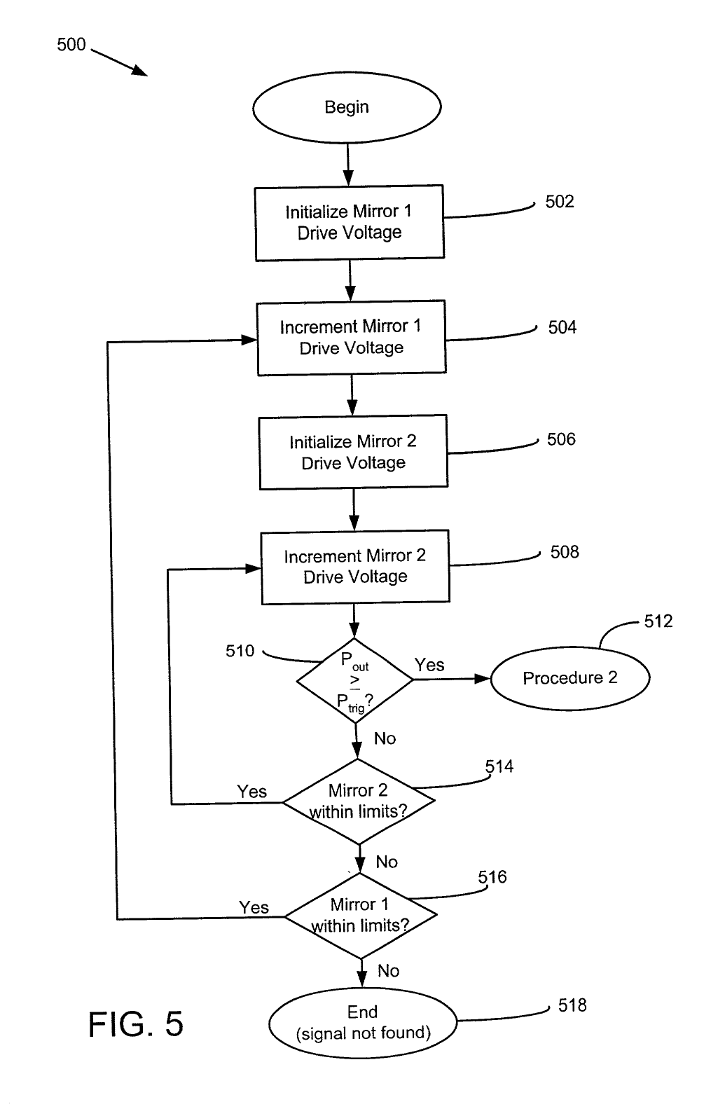

FIG. 5 is a flow chart of the coarse sweep procedure 500 of the calibration process 400 of FIG. 4. The coarse sweep procedure 500 is used for initially positioning a first mirror and second mirror in the optical signal path from the selected input port 208 (FIG. 2A) being calibrated to the selected output port 210 (FIG. 2A) being calibrated. Recall that the input and output port combination being calibrated is selected at steps 404, 406, 416, and 418 of the overall calibration process 400 shown in FIG. 4. The first and second mirrors 220 (FIG. 2A) are positioned to achieve a feedback signal 216 (FIG. 2A) with at least a predetermined feedback signal strength P_{trig}, thereby ensuring that noise in the optical calibration system does not cause the coarse sweep procedure to be terminated prematurely.

At 502, the coarse sweep procedure 500 begins by initializing the drive voltage of the first mirror in the optical signal path. Recall that in the calibration process (400 of FIG. 4), certain system variables were initialized (402 of FIG. 4) including, for each mirror, a range of drive voltages for each input and output port combination requiring use of the mirror for optical coupling. Therefore, for the first mirror in the optical signal path, the range of drive voltages includes a minimum and maximum drive voltage (V1ₘᵢₙ to V1ₘₐₓ) predicted to contain the drive voltage for the first mirror to optically couple the selected input and output port combination. At 502, the drive voltage V1 for the first mirror is initially set to the minimum drive voltage V1ₘᵢₙ.

At 504, the drive voltage V1 of the first mirror is incremented by one coarse sweep step size. As stated earlier, the sweep step size is defined in the beginning of the calibration process (400 of FIG. 4) when system variables are initialized (402 of FIG. 4). At 506, the drive voltage V2 of the second mirror in the optical signal path is initialized. For the second mirror in the optical signal path, the range of initialized drive voltages includes a minimum and maximum drive voltage (V2ₘᵢₙ to V2ₘₐₓ). At 506, the drive voltage V2 for the second mirror is initially set to the minimum drive voltage V2ₘᵢₙ. At 508, the drive voltage of the second mirror is incremented by one sweep step size.

At 510, the feedback signal strength Pₒᵤₜ of the feedback signal (216 of FIG. 2A) produced by the positions of the first and second mirror is compared to a predetermined feedback signal strength P_{trig}. If the feedback signal strength Pₒᵤₜ is greater than or equal to the predetermined feedback signal strength P_{trig}, the coarse sweep procedure 500 exits and the coarse gradient search procedure 600 (FIG. 4) is entered at 512. When the coarse sweep procedure 500 is exited at 512, the first and second mirrors are said to be placed in first and second initial positions, respectively, that produces a feedback signal 216 (FIG. 2A) with at least the predetermined feedback signal strength P_{trig}. The first and second initial positions of the first and second mirrors have an associated first and second initial drive voltages (V1ᵢₙᵢₜ and V2ᵢₙᵢₜ), respectively.

If the feedback signal strength Pₒᵤₜ is not greater than or equal to the predetermined feedback signal strength P_{trig} (510-No), the coarse sweep procedure continues at step 514, where it is determined if the drive voltage V2 of the second mirror is less than the maximum drive voltage V2ₘₐₓ allowed for the second mirror.

If the drive voltage V2 of the second mirror is less than the maximum drive voltage V2ₘₐₓ (514—Yes), the drive voltage of the second mirror is incremented by one sweep step size at 508. Steps 510 and 514 are repeated until the feedback signal strength Pₒᵤₜ produced by the positions of the first and second mirror is greater than or equal to the predetermined feedback signal strength P_{trig} (causing the coarse sweep procedure 500 to exit at 512) or until the drive voltage V2 of the second mirror is greater than the maximum drive voltage V2ₘₐₓ (514—No). If the drive voltage V2 of the second mirror is greater than the maximum drive voltage V2ₘₐₓ, step 516 is entered.

At 516, it is determined if the drive voltage V1 of the first mirror is less than the maximum drive voltage V1ₘₐₓ allowed for the first mirror. If so, the drive voltage of the first mirror is incremented by one sweep step size at 504. Steps 506 to 516 are then repeated until the feedback signal strength Pₒᵤₜ produced by the positions of the first and second mirror is greater than or equal to the predetermined feedback signal strength P_{trig} (causing the coarse sweep procedure 500 to exit at 512) or until the drive voltage V1 of the first mirror is greater than the maximum drive voltage V1ₘₐₓ (514—No). If the drive voltage V1 of the first mirror is greater than the maximum drive voltage V1ₘₐₓ, the coarse sweep procedure 500 is ended at 518. If step 518 is reached, this indicates that a feedback signal (216 of FIG. 2A) with at least the predetermined feedback signal strength P_{trig} could not be found. Therefore, the coarse sweep procedure 500 may be repeated beginning at step 502. Alternatively, the coarse sweep procedure 500 may be repeated with a wider range of drive voltages (Vₘᵢₙ and Vₘₐₓ) for the first and second mirrors so that a broader scanning range can be searched to locate a proper feedback signal. Alternatively, the coarse sweep procedure could post an error message or tag the device as uncalibratable.

### Coarse Gradient Search Procedure

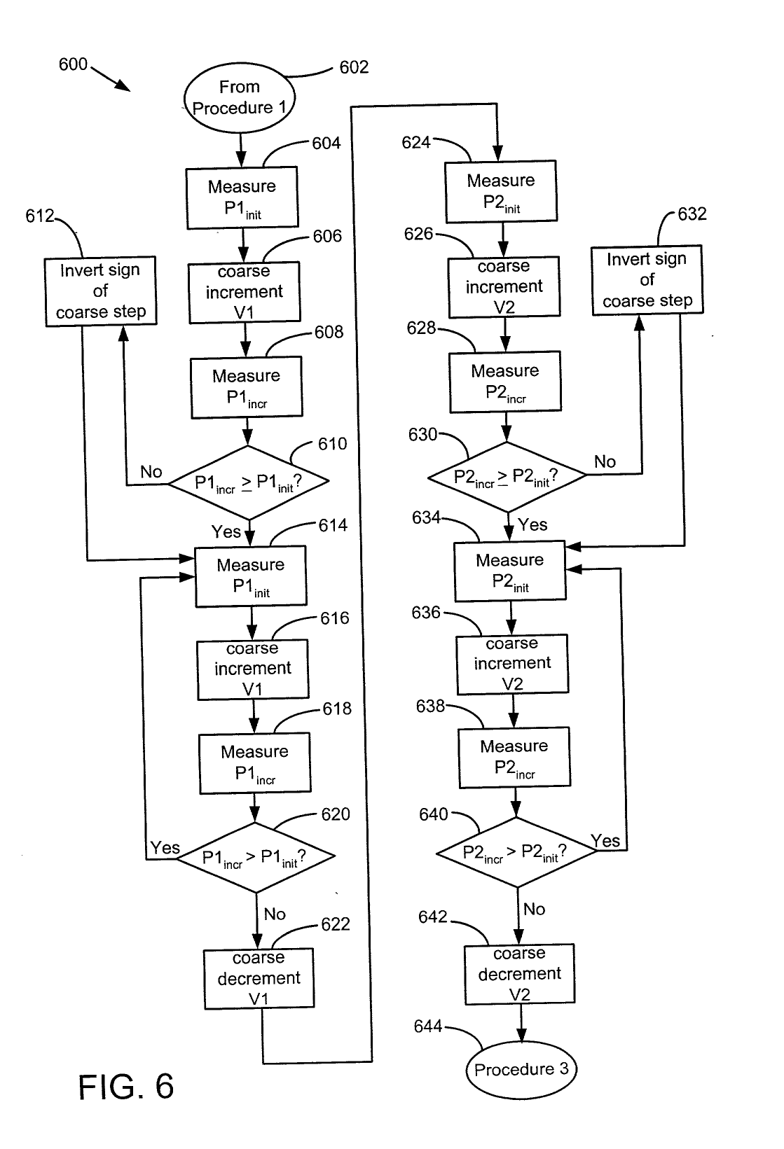

FIG. 6 is a flow chart of the coarse gradient search procedure 600 of the calibration process 400 of FIG. 4. The coarse gradient search procedure 600 is used for further positioning of the first and second mirrors relative to the first and second initial mirror positions determined by the coarse sweep procedure (500 of FIG. 5). The first and second mirrors are further positioned using a predefined coarse step size to achieve a feedback signal (216 of FIG. 2A) with a maximum feedback signal strength P_{cmax} given the coarse step size.

The coarse gradient search procedure 600 enters from the coarse sweep procedure (500 of FIG. 5) at 602. As stated above, the first and second initial positions of the first and second mirrors, as determined by the coarse sweep procedure (500 of FIG. 5), also have an associated first and second initial drive voltages (V1ᵢₙᵢₜ and V2ᵢₙᵢₜ), respectively. It should be noted that, while the position of the first mirror is adjusted from steps 604 to 622 of the coarse gradient search procedure 600, the drive voltage V2 of the second mirror is fixed at a drive voltage of V2ᵢₙᵢₜ. At 602, a drive voltage of V1ᵢₙᵢₜ is currently applied to the first mirror.

At 604, the feedback signal strength P1ᵢₙᵢₜ of the feedback signal (216 of FIG. 2A) is measured while the first mirror is at the position determined by the initial drive voltage. At 606, the drive voltage V1 of the first mirror is incremented by one coarse step size. As stated earlier, the coarse step size is defined in the beginning of the calibration process (400 of FIG. 4) when system variables are initialized (402 of FIG. 4).

At 608, the calibration system measures the feedback signal strength P1_{incr} produced while the first mirror is at the position determined by the incremented drive. At 610, it is determined if the feedback signal strength P1_{incr} associated with the incremented drive voltage of the first mirror is greater than or equal to the feedback signal strength P1_{incr} associated with the initial drive voltage of the first mirror.

If not, the sign of the coarse step size is inverted, e.g., from positive to negative, at 612. If the sign of the coarse step size is inverted at steps 612 or 632 (below), the inverted coarse step size is used in the remaining steps of the coarse gradient adjustment of the first mirror. If step 612 is reached, this indicates that the adjustment of the first mirror is producing a feedback signal strength Pₒᵤₜ that is decreasing rather than increasing. Therefore, the coarse step size applied to the drive voltage V1 of the first mirror is reversed so as to achieve an increasing feedback signal strength Pout. Step 614 is then entered.

If the feedback signal strength P1_{incr} is greater than or equal to the feedback signal strength P1ᵢₙᵢₜ (610—Yes), step 614 is entered. At 614, the calibration system measures the feedback signal strength P1ᵢₙᵢₜ when the current drive voltage is applied to first mirror. At 616, the drive voltage V1 of the first mirror is incremented by one coarse step size. If the coarse step size has been inverted to a negative coarse step size in step 612, the drive voltage V1 of the first mirror is incremented by the negative coarse step size at 616. At 618, the calibration system measures the feedback signal strength P1_{incr} of the feedback signal (216 of FIG. 2A) produced when by the incremented drive voltage is applied to first mirror. At 620, it is determined if the feedback signal strength P1_{ince} when the incremented drive voltage is applied to the first mirror is greater than the feedback signal strength P1ᵢₙᵢₜ produced when the initial drive voltage is applied to the first mirror.

If so, this indicates that the adjustment of the first mirror is producing a feedback signal strength Pₒᵤₜ that is still increasing. Therefore, a maximum feedback signal strength P1_{cmax} that is attainable given the coarse step size and the fixed drive voltage V2ᵢₙᵢₜ of the second mirror may not yet have been reached. Steps 614 to 620 are repeated until such a maximum feedback signal strength P1_{cmax} is reached. The maximum feedback signal strength P1_{cmax} should be greater than the predetermined signal strength P_{trig} used in the coarse sweep procedure (500 of FIG. 5).

If the feedback signal strength P1_{incr} produced when the incremented drive voltage is applied to the first mirror is not greater than the feedback signal strength P1ᵢₙᵢₜ produced when the initial drive voltage is applied to the first mirror (620-No), step 622 is entered. If step 622 is reached, this indicates that maximum feedback signal strength P1_{cmax} was achieved when the next to last drive voltage increment was applied to the first mirror at 616.

Therefore, at 622, the drive voltage V1 of the first mirror is decremented by one coarse step size to provide a first coarse step drive voltage V1_{c}. If the coarse step size has been inverted to a negative coarse step size in step 612, the drive voltage V1 of the first mirror is decremented by the negative coarse step size at 622.

The first coarse step drive voltage V1_{c}, produces a first coarse step position for the first mirror. Applying the first coarse step drive voltage V1_{c} to the first mirror also produces the maximum feedback signal strength P1_{cmax} that is attainable given the coarse step size and the fixed drive voltage V2ᵢₙᵢₜ of the second mirror. Alternatively, the step of decrementing the drive voltage V1 may be eliminated since, depending on the noise of a system, one coarse step size in the drive voltage of a mirror may not cause a significant change in feedback signal strength.

After the first coarse step drive voltage V1_{c} is determined at step 622, the drive voltage V1 of the first mirror is fixed at a drive voltage of V1_{c} while the position of the second mirror is adjusted from steps 624 to 642. At 624, a drive voltage of V2ᵢₙᵢₜ is applied to the second mirror. Since the procedures used to adjust the position of the second mirror in steps 624 to 642 are similar to the procedures used to adjust the position of the first mirror in steps 604 to 622, the procedures used to adjust the position of the second mirror will be explained briefly below.

At 624, the calibration system measures the feedback signal strength P2ᵢₙᵢₜ of the feedback signal (216 of FIG. 2A) produced when the current drive voltage is applied to the second mirror. At 626, the drive voltage V2 of the second mirror is incremented by one coarse step size. At 628, calibration system measures the feedback signal strength P2_{incr} produced when the incremented drive voltage is applied to the second mirror. At 630, it is determined if the feedback signal strength P2_{incr} is greater than or equal to the feedback signal strength P2ᵢₙᵢₜ. If not, the sign of the coarse step size is inverted at 632 and step 634 is then entered.

If the feedback signal strength P2_{incr} is greater than or equal to the feedback signal strength P2ᵢₙᵢₜ (630—Yes), step 634 is entered. At 634, the calibration system measures the feedback signal strength P2ᵢₙᵢₜ produced when the current drive voltage is applied to the second mirror. At 636, the drive voltage V2 of the second mirror is incremented by one coarse step size. At 638, the calibration system measures the feedback signal strength P2_{incr} produced when the incremented drive voltage is applied to the second mirror. At 630, it is determined if the feedback signal strength P2_{incr} is greater than the feedback signal strength P2ᵢₙᵢₜ.

If so, this indicates that a maximum feedback signal strength P2_{cmax} that is attainable given the coarse step size and the fixed drive voltage V1_{c} of the first mirror may not yet have been reached. Steps 634 to 640 are repeated until such a maximum feedback signal strength P2_{cmax}, is reached. The maximum feedback signal strength P2ₘₐₓ, should be greater than the maximum feedback signal strength P1_{cmax} determined above at 622.

If the feedback signal strength P2_{incr} associated with the incremented drive voltage of the second mirror is not greater than the feedback signal strength P2ᵢₙᵢₜ associated with the initial drive voltage of the second mirror (640-No), step 642 is entered. At 642, the drive voltage V2 of the second mirror is decremented by one coarse step size to provide a second coarse step drive voltage V2_{c}. The second coarse step drive voltage V2_{c} produces a second coarse step position for the second mirror. The second coarse step drive voltage V2_{c} also produces the maximum feedback signal strength P2_{cmax} that is attainable given the coarse step size and the fixed drive voltage V1_{c} of the first mirror. Alternatively, the step of decrementing the drive voltage V2 may be eliminated for the reasons given above in relation to step 622.

At 644, the coarse gradient search procedure 600 exits and fine gradient search procedure (700 of FIG. 4) is entered.

### Fine Gradient Search Procedure

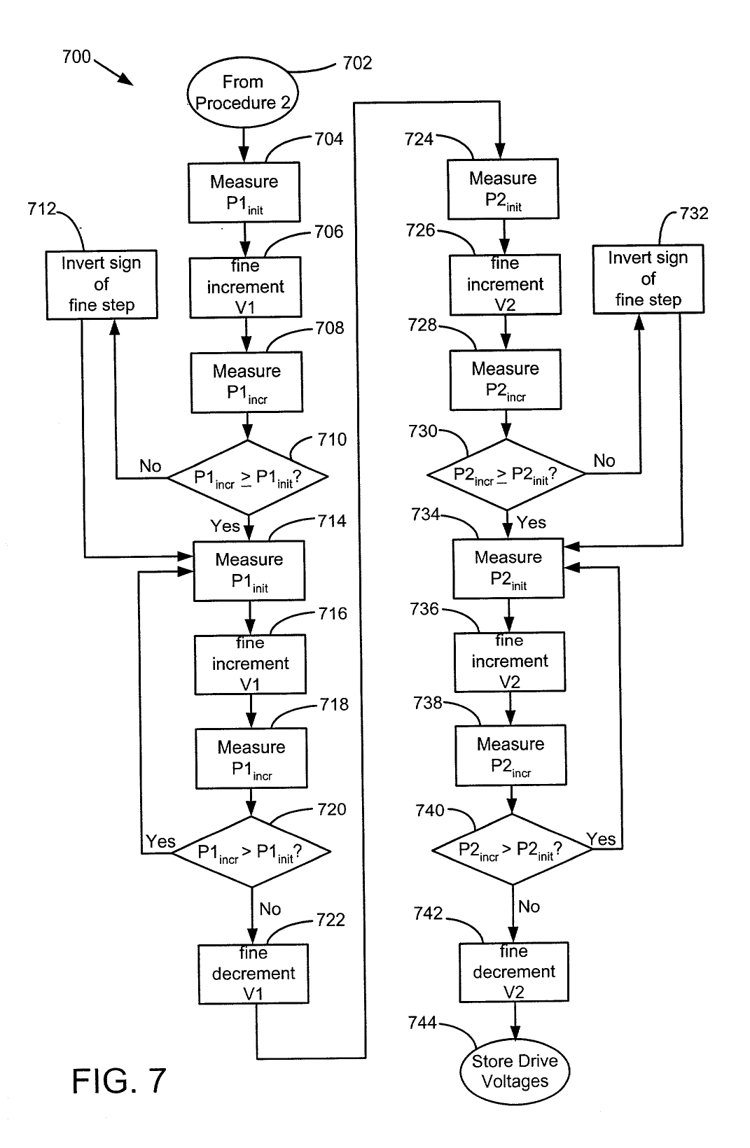

FIG. 7 is a flow chart of the fine gradient search procedure 700 for yet further positioning of the first and second mirrors, relative to the first and second coarse step positions determined by the coarse gradient search procedure (600 of FIG. 6). The further positioning of the first and second mirrors uses a predefined fine step size to achieve a feedback signal (216 of FIG. 2A) with a maximum feedback signal strength P_{fmax} given the fine step size. As stated earlier, the fine step size is defined in the beginning of the calibration process (400 of FIG. 4) when system variables are initialized (402 of FIG. 4).

The fine gradient search procedure 700 is similar to the coarse gradient search procedure (600 of FIG. 6) except in that it uses a fine step size rather than a coarse step size to adjust the position of the first and second mirrors. Therefore, the steps of the fine gradient search procedure 700 will only be briefly described below.

The fine gradient search procedure 700 enters from the coarse gradient search procedure (600 of FIG. 6) at 702. As stated above, the first and second coarse step positions of the first and second mirrors, as determined by the coarse gradient search procedure, also have an associated first and second coarse step drive voltages, V1_{c} and V2_{c}, respectively. In the fine gradient search procedure 700, while the position of the first mirror is adjusted from steps 704 to 722, the drive voltage V2 of the second mirror is fixed at a drive voltage of V2_{c}. At 702, a drive voltage of V1_{c} is currently applied to the first mirror.

At 704, the calibration system measures the feedback signal strength P1ᵢₙᵢₜ produced when the current drive voltage is applied to the first mirror. At 706, the drive voltage V1 of the first mirror is incremented by one fine step size. At 708, the calibration system measures the feedback signal strength P1_{incr} produced when the incremented drive voltage is applied to the first mirror. At 710, it is determined if the feedback signal strength P1_{incr}, is greater than or equal to the feedback signal strength Plint. If not, the sign of the fine step size is inverted at 712 and step 714 is then-entered.

At 714, the calibration system measures the feedback signal strength P1ᵢₙᵢₜ produced when the current drive voltage is applied to the first mirror. At 716, the drive voltage V1 of the first mirror is incremented by one fine step size. At 718, the calibration system measures the feedback signal strength P1_{incr} produced when the incremented drive voltage is applied to the first mirror. At 720, it is determined if the feedback signal strength P1_{incr} is greater than the feedback signal strength P1ᵢₙᵢₜ.

If so, this indicates that a maximum feedback signal strength P1_{fmax} that is attainable given the fine step size and the fixed drive voltage V2_{c} of the second mirror has not been reached. Steps 714 to 720 are repeated until such a maximum feedback signal strength P1_{fmax} is reached. The maximum feedback signal strength P1_{fmax} should be greater than the maximum feedback signal strength P2_{cmax} determined in FIG. 6 at 642.

If the feedback signal strength P1_{incr} is not greater than the feedback signal strength P1ᵢₙᵢₜ (720-No), step 722 is entered. At 722, the drive voltage V1 of the first mirror is decremented by one coarse step size to provide a first fine step drive voltage V1_{f}. The first fine step drive voltage V1_{f} produces a first fine step position for the first mirror and the maximum feedback signal strength P1_{fmax} that is attainable given the fine step size and the fixed drive voltage V2_{c} of the second mirror. Alternatively, the step of decrementing the drive voltage V1 may be eliminated.

After the first fine step drive voltage V1_{f} is determined at step 722, the drive voltage V1 of the first mirror is fixed at a drive voltage of V1_{f} while the position of the second mirror is adjusted from steps 724 to 742. At 724, a drive voltage of V2_{c} is currently applied to the second mirror.

At 724, the calibration system measures the feedback signal strength P2ᵢₙᵢₜ produced when the current drive voltage is applied to the second mirror. At 726, the drive voltage V2 of the second mirror is incremented by one fine step size. At 728, the calibration system measures the feedback signal strength P2_{incr} produced when the incremented drive voltage is applied to the second mirror. At 730, it is determined if the feedback signal strength P2_{incr} is greater than or equal to the feedback signal strength P2ᵢₙᵢₜ. If not, the sign of the fine step size is inverted at 732 and step 734 is then entered.

At 734, the calibration system measures the feedback signal strength P2ᵢₙᵢₜ produced when the current drive voltage is applied to the second mirror. At 736, the drive voltage V2 of the second mirror is incremented by one fine step size. At 738, the calibration system measures the feedback signal strength P2_{incr} produced when the incremented drive voltage is applied to the second mirror. At 740, it is determined if the feedback signal strength P2_{incr} is greater than the feedback signal strength P2ᵢₙᵢₜ.

If so, this indicates that a maximum feedback signal strength P2_{fmax} that is attainable given the fine step size and the fixed drive voltage V1_{f} of the first mirror has not been reached. Steps 734 to 740 are repeated until such a maximum feedback signal strength P2_{fmax} is reached. The maximum feedback signal strength P2_{fmax} should be at least as large as the maximum feedback signal strength P1_{fmax} determined above at 722.

If the feedback signal strength P2_{incr} is not greater than the feedback signal strength P2ᵢₙᵢₜ (740—No), step 742 is entered. At 742, the drive voltage V2 of the second mirror is decremented by one fine step size to provide a second fine step drive voltage V2_{f}. The second fine step drive voltage V2_{f} produces a second fine step position for the second mirror and the maximum feedback signal strength P2_{fmax}, that is attainable given the fine step size and the fixed drive voltage V1_{f} of the first mirror. Alternatively, the step of decrementing the drive voltage V2 may be eliminated.

At 744, the first and second fine step drive voltages, V1_{f} and V2_{f}, that produce the first and second fine step positions for the first and second mirrors, respectively, are stored as calibration values in a storage device. The calibration values are stored for the input and output port combination selected to be calibrated at steps 404, 406, 416, and 418 of the overall calibration process 400 (as shown in FIG. 4). Preferably, the storage device is the memory device (350 of FIG. 3) contained in the controller (300 of FIG. 2A).

The first and second fine step drive voltages, V1_{f} and V2_{f}, produce a maximum feedback signal strength P2_{fmax} that is greater the maximum feedback signal strengths P1_{cmax}, P2_{cmax}, and P1_{fmax} achieved in the prior steps 622 of FIG. 6, 642 of FIG. 6, and 722, respectively. The maximum feedback signal strength P2_{fmax} may be considered approximate to the global maximum feedback signal strength for the selected input and output port combination. Achieving a global maximum feedback signal strength for a selected input and output port combination implies that the first and second mirrors are optimally positioned to reflect the optical signal (224 of FIG. 2A) from the selected input port to the selected output port.

### Alternate Embodiments

It should be appreciated that although the above description primary describes the optical switch modules as containing mirrors, any suitable optical components may be substituted.

In an alternate embodiment, when the calibration process is used to calibrate a optical switch containing mirror mounts with two degrees of freedom, the first and second degrees of freedom of each mirror are calibrated simultaneously, instead of one after the other. In particular, during each stage of the calibration, the mirror is moved through a two dimensional raster scan pattern of positions until the stop condition for that calibration stage is reached, or until the raster scan pattern is completed and a best position is identified and then used either as the final calibration position or as the starting position for the next calibration stage. The raster scan calibration methodology may be used for one or more of the calibration steps (e.g., the coarse sweep procedure) while independent first and second degree of freedom calibrations are used for the other calibration steps.

The foregoing descriptions of specific embodiments of the present invention are presented for purposes of illustration and description. They are not intended to be exhaustive or to limit the invention to the precise forms disclosed, obviously many modifications and variations are possible in view of the above teachings. For example, modules other than a 2N type optical switch module can be used in the present invention. Also, non MEMS optical components may be used, if appropriate. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. An optical calibration system comprising:
an optical switch having
a mirror coupled to a mirror mount having one or more degrees of freedom for positioning the mirror in response to a control signal;
an input port configured for receiving an optical signal from an optical signal source;
and an output port;
an optical signal detector optically coupled to the optical switch by the output port to receive the optical signal and to generate in response a feedback signal having an associated feedback signal strength;
a controller comprising a central processing unit and a memory device, wherein the controller is coupled to the optical signal detector to receive the feedback signal and is coupled to the mirror mount for sending the control signal to the mirror mount to position the mirror;
the memory device containing instructions executable by the central processing unit the instructions including:
instructions for operating the mirror mount to position the mirror to optically couple the input port to the output port comprising:
coarse sweep instructions for positioning the mirror at an initial position to achieve a feedback signal with at least a predetermined feedback signal strength;
coarse gradient instructions for further positioning of the mirror, relative to the initial position, at a sequence of coarse step positions separated in accordance with a predefined coarse step size and identifying one of the coarse step positions for which the feedback signal has a maximum feedback signal strength;
fine gradient instructions for further positioning of the mirror, relative to the identified coarse step position, at a sequence of fine step positions separated in accordance with a predefined fine step size and identifying one of the fine step positions for which the feedback signal has a maximum feedback signal strength; and
calibration storage instructions for storing into a storage device calibration values associated with the identified fine step position.

2. The optical calibration system of claim 1, the memory device further including:
switch control instructions for operating the optical switch so as to optically couple the input port to the output port using the calibration values stored in the storage device.

3. The optical calibration system of claim 1 wherein the optical switch is a micro-optical-electromechanical switch.

4. The optical calibration system of claim 1 wherein the optical switch and the controller are contained within the same housing.

5. The optical calibration system of claim 1 wherein the storage device is a memory medium internal to the controller.

6. The optical calibration system of claim 1 wherein the storage device is a memory medium internal to the optical switch.

7. The optical calibration system of claim 1 wherein the storage device is a memory medium external to the optical calibration system.

8. An optical calibration system comprising:
an optical switch having
a mirror coupled to a mirror mount having one or more degrees of freedom for positioning the mirror in response to a control signal;
an input port configured for receiving an optical signal from an optical signal source;
and a plurality of discrete output ports capable of being optically coupled by the optical switch to the input port;
an optical signal detector optically coupled to the optical switch by the plurality of output ports to receive the optical signal and to generate in response a feedback signal having an associated feedback signal strength;
a controller comprising a central processing unit and a memory device, wherein the controller is coupled to the optical signal detector to receive the feedback signal and is coupled to the mirror mount for sending the control signal to the mirror mount to position the mirror;
the memory device containing instructions executable by the central processing unit the instructions including:
instructions for operating the mirror mount to position the mirror to optically couple the input port to each of the plurality of output ports comprising:
calibration control instructions for successively selecting each output port of the plurality of output ports;
coarse sweep instructions for positioning the mirror at an initial position associated with the selected output port to achieve a feedback signal with at least a predetermined feedback signal strength;
coarse gradient instructions for further positioning of the mirror, relative to the initial position, at a sequence of coarse step positions separated in accordance with a predefined coarse step size and identifying one of the coarse step positions for which the feedback signal has a maximum feedback signal strength;
fine gradient instructions for further positioning of the mirror, relative to the identified coarse step position, at a sequence of fine step positions separated in accordance with a predefined fine step size and identifying one of the fine step positions for which the feedback signal has a maximum feedback signal strength; and
calibration storage instructions for storing into a storage device calibration values associated with the identified fine step position.

9. The optical calibration system of claim 8, wherein
the calibration control instructions include instructions for initiating execution of the coarse sweep, coarse gradient, fine gradient and calibration storage instructions for each selected output port.

10. The optical calibration system of claim 9, wherein
the storage device stores distinct calibration values for coupling the input port to each output port of the plurality of output ports; and
the memory device further includes switch control instructions for operating the optical switch so as to optically couple the input port to any specified output port of the plurality of output ports using the corresponding distinct calibration values stored in the storage device.

11. The optical calibration system of claim 8 wherein the optical switch is a micro-optical-electromechanical switch.

12. The optical calibration system of claim 8 wherein the optical switch and the controller are contained within the same housing.

13. The optical calibration system of claim 8 wherein the storage device is a memory medium internal to the controller.

14. The optical calibration system of claim 8 wherein the storage device is a memory medium internal to the optical switch.

15. The optical calibration system of claim 8 wherein the storage device is a memory medium external to the optical calibration system.

16. An optical calibration system comprising:
an optical switch having
first and second mirrors coupled to first and second mirror mounts, respectively, for positioning the first and second mirrors in response to control signals;
an input port configured for receiving an optical signal from an optical signal source;
and an output port;
an optical signal detector optically coupled to the optical switch by the output port to receive the optical signal and to generate in response a feedback signal having an associated feedback signal strength;
a controller comprising a central processing unit and a memory device, wherein the controller is coupled to the optical signal detector to receive the feedback signal and is coupled to the first and second mirrors mounts for sending the control signals to the first and second mirror mounts to position the first and second mirrors;
the memory device containing instructions executable by the central processing unit the instructions including:
instructions for operating the first and second mirror mounts to position the first and second mirrors, respectively, to optically couple the input port to the output port comprising:
coarse sweep instructions for positioning the first and second mirrors at first and second initial positions, respectively, to achieve a feedback signal with at least a predetermined feedback signal strength;
coarse gradient instructions for further positioning of the first and second mirrors, relative to the first and second initial positions, at first and second sequences of coarse step positions separated in accordance with first and second predefined coarse step sizes and identifying a pair of coarse step positions, comprising one of the first coarse step positions and one of the second coarse step positions, for which the feedback signal has a maximum feedback signal strength;
fine gradient instructions for further positioning of the first and second mirrors, relative to the identified first and second coarse step positions, respectively, at first and second sequences of fine step positions separated in accordance with first and second predefined fine step sizes and identifying a pair of fine step positions, comprising one of the first fine step positions and one of the second fine step positions, for which the feedback signal has a maximum feedback signal strength; and
calibration storage instructions for storing into a storage device calibration values associated with the identified pair of fine step positions.

17. The optical calibration system of claim 16, the memory device further including:
switch control instructions for operating the optical switch so as to optically couple the input port to the output port using the calibration values stored in the storage device.

18. The optical calibration system of claim 16 wherein the optical switch is a micro-optical-electromechanical switch.

19. The optical calibration system of claim 16 wherein the optical switch and the controller are contained within the same housing.

20. The optical calibration system of claim 16 wherein the storage device is a memory medium internal to the controller.

21. The optical calibration system of claim 16 wherein the storage device is a memory medium internal to the optical switch.

22. The optical calibration system of claim 16 wherein the storage device is a memory medium external to the optical calibration system.

23. An optical calibration system comprising:
an optical switch having:
first and second mirrors coupled to first and second mirror mounts, respectively, for positioning the first and second mirrors in response to control signals;
an input port configured for receiving an optical signal from an optical signal source;
and a plurality of discrete output ports capable of being optically coupled by the optical switch to the input port;
an optical signal detector optically coupled to the optical switch by the plurality of output ports to receive the optical signal and to generate in response a feedback signal having an associated feedback signal strength;
a controller comprising a central processing unit and a memory device, wherein the controller is coupled to the optical signal detector to receive the feedback signal and is coupled to the first and second mirror mounts for sending the control signals to the first and second mirror mounts to position the first and second mirrors;
the memory device containing instructions executable by the central processing unit the instructions including:
calibration control instructions for successively selecting each output port of the plurality of output ports;
instructions for operating the first and second mirror mounts to position the first and second mirrors, respectively, to optically couple the input port to the selected output port comprising:
coarse sweep instructions for positioning the first and second mirrors at first and second initial positions, respectively, associated with the selected output port to achieve a feedback signal with at least a predetermined feedback signal strength;
coarse gradient instructions for further positioning of the first and second mirrors, relative to the first and second initial positions, at first and second sequences of coarse step positions separated in accordance with first and second predefined coarse step sizes and identifying a pair of coarse step positions, comprising one of the first coarse step positions and one of the second coarse step positions, for which the feedback signal has a maximum feedback signal strength;
fine gradient instructions for further positioning of the first and second mirrors, relative to the identified first and second coarse step positions, respectively, at first and second sequences of fine step positions separated in accordance with first and second predefined fine step sizes and identifying a pair of fine step positions, comprising one of the first fine step positions and one of the second fine step positions, for which the feedback signal has a maximum feedback signal strength; and
calibration storage instructions for storing into a storage device calibration values associated with the identified pair of fine step positions.

24. The optical calibration system of claim 23, wherein
the calibration control instructions include instructions for initiating execution of the coarse sweep, coarse gradient, fine gradient and calibration storage instructions for each selected output port.

25. The optical calibration system of claim 24, wherein
the storage device stores distinct calibration values for coupling the input port to each output port of the plurality of output ports; and
the memory device further includes switch control instructions for operating the optical switch so as to optically couple the input port any specified output port of the plurality of output ports using the corresponding distinct calibration values stored in the storage device.

26. The optical calibration system of claim 23 wherein the optical switch is a micro-optical-electromechanical switch.

27. The optical calibration system of claim 23 wherein the optical switch and the controller are contained within the same housing.

28. The optical calibration system of claim 23 wherein the storage device is a memory medium internal to the controller.

29. The optical calibration system of claim 23 wherein the storage device is a memory medium internal to the optical switch.

30. The optical calibration system of claim 23 wherein the storage device is a memory medium external to the optical calibration system.

31. An optical calibration system comprising:
optical switch having
a mirror coupled to a mirror mount having two degrees of freedom for positioning the mirror in response to a control signal;
an input port configured for receiving an optical signal from an optical signal source;
and an output port;
an optical signal detector optically coupled to the optical switch by the output port to receive the optical signal and to generate in response a feedback signal having an associated feedback signal strength;
a controller comprising a central processing unit and a memory device, wherein the controller is coupled to the optical signal detector to receive the feedback signal and is coupled to the mirror mount for sending the control signal to the mirror mount to position the mirror;
the memory device containing instructions executable by the central processing unit the instructions including:
instructions for operating the mirror mount to position the mirror to optically couple the input port to the output port comprising:
coarse sweep instructions for positioning the mirror at a sequence of coarse sweep positions so as to identify an initial position of the mirror for which a feedback signal with at least a predetermined feedback signal strength is detected by the optical signal detector;
coarse gradient instructions for further positioning of the mirror, relative to the initial position, at a sequence of coarse step positions separated in accordance with a predefined coarse step size and identifying one of the coarse step positions for which the feedback signal has a maximum feedback signal strength;
fine gradient instructions for further positioning of the mirror, relative to the identified coarse step position, at a sequence of fine step positions separated in accordance with a predefined fine step size and identifying one of the fine step positions for which the feedback signal has a maximum feedback signal strength; the fine gradient positions including positions differing from each other with respect to each of the two degrees of freedom; and
calibration storage instructions for storing into a storage device calibration values associated with the identified fine step position.

32. The optical calibration system of claim 31 wherein the coarse step positions include positions differing from each other with respect to each of the two degrees of freedom.

33. The optical calibration system of claim 32, wherein the coarse sweep positions include positions differing from each other with respect to each of the two degrees of freedom.

34. The optical calibration system of claim 31, the memory device further including:
switch control instructions for operating the optical switch so as to optically couple the input port to the output port using the calibration values stored in the storage device.

35. The optical calibration system of claim 31 wherein the optical switch is a micro-optical-electromechanical switch.

36. The optical calibration system of claim 31 wherein the optical switch and the controller are contained within the same housing.

37. The optical calibration system of claim 31 wherein the storage device is a memory medium internal to the controller.

38. The optical calibration system of claim 31 wherein the storage device is a memory medium internal to the optical switch.

39. The optical calibration system of claim 31 wherein the storage device is a memory medium external to the optical calibration system.

40. A optical calibration method for calibrating an optical switch containing a mirror configured to have one or more degrees of freedom, an input port receiving an optical signal from an optical signal source, and an output port, the method comprising:
positioning the mirror at an initial position so as to direct to the output port a reflected optical signal with at least a predetermined signal strength;
further positioning the mirror, relative to the initial position, at a sequence of coarse step positions separated in accordance with a predefined coarse step size and identifying one of the coarse step positions for which the reflected optical signal has a maximum signal strength;
further positioning the mirror, relative to the identified coarse step position, at a sequence of fine step positions separated in accordance with a predefined fine step size and identifying one of the fine step positions for which the reflected optical signal has a maximum signal strength; and
storing calibration values associated with the identified fine step position.

41. The method of claim 40, including
operating the optical switch so as to optically couple the input port to the output port using the stored calibration values.

42. A optical calibration method for calibrating an optical switch containing a mirror configured to have one or more degrees of freedom, an input port receiving an optical signal from an optical signal source, and a plurality of discrete output ports capable of being optically coupled by the optical switch to the input port, the method comprising:
selecting an output port of the plurality of output ports;
positioning the mirror at an initial position so as to direct to the selected output port a reflected optical signal with at least a predetermined signal strength;
further positioning the mirror, relative to the initial position, at a sequence of coarse step positions separated in accordance with a predefined coarse step size and identifying one of the coarse step positions for which the reflect ed optical signal has a maximum signal strength;
further positioning the mirror, relative to the identified coarse step position, at a sequence of fine step positions separated in accordance with a predefined fine step size and identifying one of the fine step positions for which the reflected optical signal has a maximum signal strength;
storing calibration values associated with the identified fine step position; and
repeating the selection, positioning and storing steps for each of the plurality of output ports so as to generate and store distinct calibration values for each of the plurality of output ports.

43. The method of claim 42, including
operating the optical switch so as to optically couple the input port to any specified output port of the plurality of output ports using the corresponding distinct stored calibration values.

44. An optical calibration method for calibrating an optical switch containing first and second mirrors, an input port receiving an optical signal from an optical signal source, and an output port, the method comprising:
positioning the first and second mirrors at first and second initial positions, respectively, so as to direct to the output port a reflected optical signal with at least a predetermined signal strength;
further positioning the first and second mirrors, relative to the first and second initial positions, at first and second sequences of coarse step positions separated in accordance with first and second predefined coarse step sizes and identifying a pair of coarse step positions, comprising one of the first coarse step positions and one of the second coarse step positions, for which the feedback signal has a maximum feedback signal strength;
further positioning the first and second mirrors, relative to the identified first and second coarse step positions, respectively, at first and second sequences of fine step positions separated in accordance with first and second predefined fine step sizes and identifying a pair of fine step positions, comprising one of the first fine step positions and one of the second fine step positions, for which the feedback signal has a maximum feedback signal strength; and
storing calibration values associated with the identified pair of fine step positions.

45. The method of claim 44, including
operating the optical switch so as to optically couple the input port to the output port using the stored calibration values.

46. An optical calibration method for calibrating an optical switch containing first and second mirrors, an input port receiving an optical signal from an optical signal source, and a plurality of discrete output ports capable of being optically coupled by the optical switch to the input port, the method comprising:
selecting an output port of the plurality of output ports;
positioning the first and second mirrors at first and second initial positions, respectively, so as to direct to the selected output port a reflected optical signal with at least a predetermined signal strength;
further positioning the first and second mirrors, relative to the first and second initial positions, at first and second sequences of coarse step positions separated in accordance with first and second predefined coarse step sizes and identifying a pair of coarse step positions, comprising one of the first coarse step positions and one of the second coarse step positions, for which the feedback signal has a maximum feedback signal strength;
further positioning the first and second mirrors, relative to the identified first and second-coarse step positions, respectively, at first and second sequences of fine step positions separated in accordance with first and second predefined fine step sizes and identifying a pair of fine step positions, comprising one of the first fine step positions and one of the second fine step positions, for which the feedback signal has a maximum feedback signal strength;
storing calibration values associated with the identified pair of fine step positions; and
repeating the selecting, positioning, and storing steps for each of the plurality of output ports so as to generate and store distinct calibration values for each of the plurality of output ports.

47. The method of claim 46, including
operating the optical switch so as to optically couple the input port to any specified output port of the plurality of output ports using the corresponding distinct stored calibration values.

48. An optical calibration method for calibrating an optical switch containing a mirror configured to have two degrees of freedom, an input port receiving an optical signal from an optical signal source, and an output port, the method comprising:
positioning the mirror at an initial position so as to direct to the output port a reflected optical signal with at least a predetermined signal strength;
further positioning the mirror, relative to the initial position, at a sequence of coarse step positions separated in accordance with a predefined coarse step size and identifying one of the coarse step positions for which the reflected optical signal has a maximum signal strength;
further positioning the mirror, relative to the identified coarse step position, at a sequence of fine step positions separated in accordance with a predefined fine step size and identifying one of the fine step positions for which the reflected optical signal has a maximum signal strength, the fine gradient positions including positions differing from each other with respect to each of the two degrees of freedom; and
storing calibration values associated with the identified fine step position.

49. The method of claim 48 wherein the coarse step positions include positions differing from each other with respect to each of the two degrees of freedom.

50. The method of claim 49, wherein the coarse sweep positions include positions differing from each other with respect to each of the two degrees of freedom.

51. The method of claim 48, including
operating the optical switch so as to optically couple the input port to the output port using the stored calibration values.
